(19) United States
(12) Patent Application Publication
(10) Pub. No.: US 2006/0284107 A1
(43) Pub. Date: Dec. 21, 2006

(54) Device for ionization of fluids, especially of water, alcoholic and non-alcoholic drinks

(76) Inventor: Vladimir Silektis, Bratislava (SK)

Correspondence Address: OPPEDAHL & OLSON LLP, P.O. BOX 4850, FRISCO, CO, 80443-4850, US

(21) Appl. No.: 10/555,681

(22) PCT Filed: Apr. 2, 2004
(86) PCT No.: PCT/SK04/00004

§ 371 Date: Nov. 4, 2005

(30) Foreign Application Priority Data
May 21, 2003 (SK) PUV 110-03

(51) Int. Cl. G01N 23/12

(52) U.S. Cl. 250/432 R

(57) ABSTRACT

Device, suitable for ionization of fluids, especially of water, alcoholic and non-alcoholic drinks, according to the solution consists in that it comprises a chamber (1) and vessel (2). Chamber (1), which has a cylindrical or conical or square or oblong or spherical shape, is provided with material (3) and an inlet (4) for feeding the fluid. The device further consists of a fluid outlet (5), wherein the fluid outlet (5) and vessel (2) are possibly interconnected by a ground joint with a valve (6). Material consists of particles having a diameter of 0.001 mm to 10 m, which have been irradiated in advance by solar radiation in the wavelength range of 300 to 2500 nm for at least an hour.

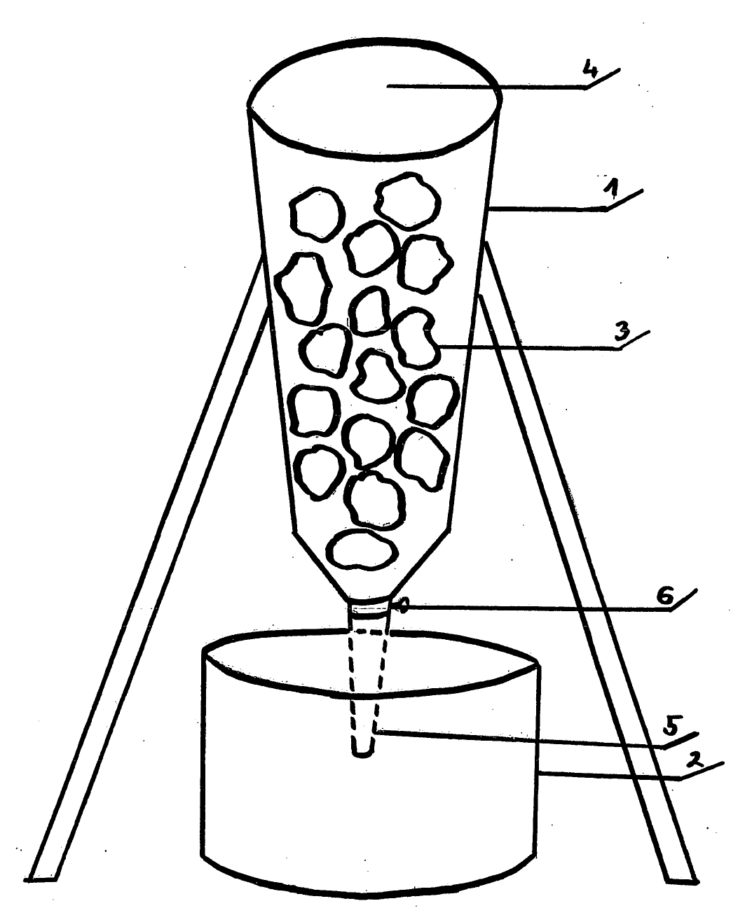

### TECHNICAL FIELD

Present solution relates to a device for ionization of fluids, especially of water, alcoholic and non-alcoholic drinks.

### BACKGROUND ART

In view of considerable physical and psychological stress of people a great attention is presently paid to increasing resistivity, drawing energy and making organism healthier.

At present various preparations and nutritional supplements are used for stimulating and making organism healthier. To the preparations for ensuring especially the mineral balance in the organism, Which are intended mainly for sportsmen, belong various ionic drinks.

The ionic drinks have been up to now prepared by enriching water or other drinks by ions of sodium, potassium or magnesium, or they are possibly enriched by vitamins or a combination of the amino acids carnitine or taurine.

The aim of the present solution is ionization of fluids, especially of water, alcoholic and non-alcoholic drinks, by means of a device in such a way that no changes in their physico-chemical composition encounter, preserving the flavour properties, and no side effects occur.

### DISCLOSURE OF TECHNICAL SOLUTION

The subject-matter of a device according to the present solution consists in that it comprises a chamber, which is provided with ionizing material, an inlet for feeding the fluid and an outlet for the ionized fluid, wherein the fluid outlet and the collecting vessel are interconnected by a ground joint with a valve.

It has been found preferred if the chamber had a cylindrical or conical or square or oblong or spherical shape.

The material consists of particles having a diameter of 0.001 mm to 10 mm, which have been irradiated by solar radiation in the wavelength range of 300 to 2500 nm for at least an hour.

It has been found that it is preferable to use a material consisting of natural untreated stones of various shapes.

A device according to the present solution requires minimal costs, while the ionized fluids obtained in this way do not loose their physico-chemical and flavour properties.

### A SURVEY OF THE FIGURES IN THE DRAWING

An example of embodiment of the technical solution, which is the subject of protection, is schematically shown in the appended FIGURE.

### EXAMPLES OF EMBODIMENTS

A device suitable for ionization of fluids according to the FIGURE consists of a chamber 1, which is provided with ionizing material 3, an inlet 4 for feeding the fluid and a fluid outlet 5. Chamber 1 and the collecting vessel 2 are possibly interconnected by a ground joint with a valve 6.

It has been found that it is preferred when the material particles have dimensions of at least the fluid outlet diameter and at most the diameter of the inlet 4 for feeding the fluid. Chamber 1 may have a cylindrical or conical or square or oblong or spherical shape.

When ionizing water, chamber 1 was filled up to ⅔ of its height by material 3, which consisted of stones obtained from lava and having diameter of 0.2 m, which had been irradiated by solar rays in the wavelength approximately of 700 nm for 2.5 hours. After having closed the valve at the orifice 5, drinking water started to be poured through the orifice 4 into the chamber 1. After 3 minutes of treatment the valve 6 at the orifice 5 is opened and the ionized water is discharged into the collecting vessel 2.

1. (canceled)

2. (canceled)

3. (canceled)

4. (canceled)

5. A device, suitable for ionization of fluids, especially of water, alcoholic and non-alcoholic drinks, characterized in that it comprises a chamber (1), which is provided with material (3), an inlet (4) for feeding the fluid and a fluid outlet (5).

6. The device of claim 5 further comprising a vessel, wherein the outlet (5) and vessel (2) are interconnected by a ground joint with a valve (6).

7. The device according to claim 5, characterized in that the material consists of particles having a diameter of 0.001 mm to 10 mm, which have been irradiated by solar radiation in the wavelength range of 300 to 2500 nm for at least an hour.

8. The device according to claim 7, characterized in that the diameter of the material particles equals to at least the outlet (5) diameter and at most the diameter of the inlet (4).

9. The device according to claim 5, characterized in that the chamber (1) has a cylindrical or conical or square or oblong or spherical shape.

10. A method comprising the steps of:
irradiating particles by solar radiation in the wavelength range of 300 to 2500 nanometers for at least an hour; treating a liquid by putting the liquid in contact with the particles; discharging the liquid from contact with the particles.

11. The method of claim 10 wherein the particles have a diameter of 0.001 millimeters to 10 millimeters.

12. The method of claim 10 wherein the particles are natural untreated stones.

13. The method of claim 12 wherein the particles are of various shapes.

14. The method of claim 10 wherein the particles are obtained from lava.

15. The method of claim 10 wherein the irradiation lasts 2.5 hours.
